(19) United States
(12) Patent Application Publication
(10) Pub. No.: US 2026/0280203 A1
(43) Pub. Date: Sep. 17, 2026

(54) CONTACTING ELEMENT FOR A CONTACT ASSEMBLY AND A CONTACT ASSEMBLY FOR SHIELDED CONNECTORS

(71) Applicant: TE Connectivity Solutions GmbH, Schaffhausen (CH)

(72) Inventor: Olivier DE CLOET, Bensheim (DE)

(21) Appl. No.: 19/563,178

(22) Filed: Mar. 11, 2026

(30) Foreign Application Priority Data
Mar. 14, 2025 (DE) 102025109932.4

(51) Int. Cl. H01R 24/84; H01R 13/6581

(52) U.S. Cl. CPC H01R 24/84; H01R 13/6581

(57) ABSTRACT

Contacting element for a contact assembly with a cable-side end and a plug-side end having a first lamella arrangement with at least two lamellae radially opposite each other with respect to a center axis of the contacting element and a second lamella arrangement with at least two lamellae radially opposite each other with respect to the center axis of the contacting element. The lamellae of the first lamella arrangement and the lamellae of the second lamella arrangement are arranged at the plug-side end in a circumferential direction extending around the center axis at the plug-side end. The second lamella arrangement is offset from the first lamella arrangement in the circumferential direction. The contacting element is configured to be plugged together with a further contacting element with an identical plug-side end along a plugin direction.

### CROSS REFERENCE TO RELATED APPLICATIONS

This application claims the benefit of DE Application No. 102025109932.4 filed 14 Mar. 2025, the subject matter of which is herein incorporated by reference in its entirety.

### BACKGROUND OF THE INVENTION

The subject matter herein relates to a contacting element for a contact assembly and a contact assembly for shielded connectors.

Shielded connectors, such as coaxial connectors, have a concentric cross-sectional structure in order to maintain the advantages of coaxial cables, the ends of which are connected to the coaxial connectors. This ensures low electromagnetic interference and radiation as well as good electrical shielding.

The problem with coaxial connectors is that different tools are required for the manufacture of the connector and the complementary connector, as they are shaped differently. On the one hand, the specified tolerances for the connector and the complementary connector may differ and must be precisely adhered to in order to ensure that the connector and the complementary connector fit together correctly. This means that manufacturing is very costly.

There is a need for manufacturing shielded connectors, such as coaxial connectors, with little effort.

### BRIEF DESCRIPTION OF THE INVENTION

In one embodiment, a genderless connector is provided. The connector end can be plugged together with itself, whereby the term “can be plugged together with itself” is explained in more detail below.

In an embodiment, a contacting element for a contact assembly, in particular a coaxial connector, is provided with a cable-side end and a plug-side end, wherein the plug-side end comprises a first lamella arrangement with at least two lamellae radially opposite each other with respect to a center axis of the contacting element and a second lamella arrangement with at least two lamellae radially opposite each other with respect to the center axis of the contacting element, wherein the lamellae of the first lamella arrangement and the lamellae of the second lamella arrangement are arranged in a circumferential direction extending around the center axis at the plug-side end, wherein the second lamella arrangement is offset in the circumferential direction relative to the first lamella arrangement, and wherein the contacting element is configured to be plugged together with a further contacting element having an identical plug-side end along a plug-in direction. The need is further met by a contact assembly and a set of contact assemblies.

This solution enables a reduction in manufacturing costs and a reduction in the number of parts required, thus simplifying the manufacture of connectors and enabling a compact design.

The subject matter herein can be further improved by the following embodiments, each of which is advantageous in itself and can be combined with each other as desired.

The contacting element may comprise a polygonal cross-section. For example, the contacting element may comprise a square cross-section or a rectangular cross-section. With such a cross-section, the contacting element may thus be approximately cuboid in shape overall. Other embodiments may comprise a round cross-section. In particular, the contacting element may be rotationally symmetrical and, for example, cylindrical in shape. The cross-section may be located in a cross-sectional plane that has the plug-in direction as its normal. The center axis may run along the length of the contacting element, i.e., be aligned along the length of the contacting element. In particular, the center axis and the insertion direction may run parallel to each other. A radial direction, such as the direction of the radially arranged lamellae of a lamella arrangement, may always run perpendicular to this straight line.

The lamellae of the first lamellae arrangement, also referred to as primary lamellae for simplicity, and/or the lamellae of the second lamellae arrangement, also referred to as secondary lamellae, may be arranged diametrically. When the term “lamellae” is used in this text, it refers to both the primary and secondary lamellae. Where the difference is important, the corresponding terms are used.

The lamellae of a lamella arrangement can be arranged at two opposite points on the cross-sectional circumference. These can be two points or positions that are particularly far apart, for example in the case of a round cross-section. The points can be located on two opposite sides of the cross-section. In this case, the lamellae of a lamella arrangement can be arranged at the center point of one side of the square cross-section, for example, or diagonally at two opposite corners of the cross-section.

An embodiment of the contacting element can therefore comprise a total of four lamellae, whereby each lamella arrangement can comprise two lamellae that are radially opposite each other and are arranged, for example, at the center point of each side of the square or rectangular cross-section.

A lamella arrangement may comprise more than two lamellae. In particular, the lamella arrangement may comprise two or more lamellae on each side, for example on two opposite sides. Thus, on one side of the cross-section, two or more lamellae may be arranged next to each other along the side. At least one lamella may be arranged on the opposite side of the cross-section. The opposite side may comprise the same number of slats in order to achieve a symmetrical design.

The lamellae of a lamella arrangement can, but do not necessarily have to be configured as thin tongues. The thickness can vary depending on the specific application. For example, the lamellae of a lamella arrangement can be configured as thin, easily elastically deflectable under low force, or, for example, as jaw-shaped or as rigid jaws. For the elastic embodiment, the lamellae can each comprise a recess along the direction of the center axis, which, for example, enables targeted elastic deflection of the respective lamella in the area around the recess. The recess can be configured in the form of an elongated hole, the longest extension of which can run along the center axis. The recess can also provide space for at least one section of a further part, for example an insulating body or a further contacting element, which can be advantageous for a minimum required material thickness during forming.

In one embodiment, the lamellae may each comprise at least one bend along the direction of the center axis. The outside of the bend or curvature, i.e., the side that is stretched and not compressed, may extend toward the center axis or point away from the center axis. This can increase the flexibility of the respective lamella, for example, in the direction of the bend, which is advantageous for better contacting with a counter element.

The following explanations regarding the first lamella arrangement and the primary lamellae also apply to the second lamella arrangement and the secondary lamellae, and vice versa.

The secondary lamellae may be offset in the circumferential direction relative to the primary lamellae in such a way that the primary lamellae and the secondary lamellae are equidistant from each other. An imaginary radial line running through the oppositely arranged primary lamellae, can intersect an imaginary radial line of the oppositely arranged secondary lamellae, for example, perpendicularly. An equidistant arrangement ensures uniformity in signal transmission and facilitates calculation and design, as equal distances between elements provide clear and predictable results.

The lamellae of at least one lamella arrangement can be fork-shaped, whereby the lamellae of at least one lamella arrangement can run along the center axis. For example, the primary lamellae can run along the center axis parallel to the secondary lamellae. In particular, the lamellae of a lamella arrangement can protrude along the center axis from the plug-side end of the contacting element. The lamellae of at least one lamella arrangement can extend along the center axis away from the plug-side end or the rest of the contacting element.

The primary lamellae and the secondary lamellae can be formed on the outer circumference of the contacting element. In the circumferential direction, the primary lamellae may be arranged alternately with the secondary lamellae. Thus, a secondary lamella may be spaced apart from a primary lamella in the circumferential direction. Viewed further in the circumferential direction, the primary lamella opposite the first primary lamella may be spaced apart from the secondary lamella described above. In the circumferential direction, a secondary lamella may be positioned between the two primary lamellae. In other words, in the circumferential direction, a primary lamella may be arranged first, then a secondary lamella, then another primary lamella, and then another secondary lamella along the entire circumference. This arrangement supports the contact force.

The contacting element may be configured to receive another, in particular identical, contacting element coaxially at least in sections. The further contacting element may be rotated around the center axis relative to the first contacting element. The contacting element can thus be connected to itself along a plug-in direction.

In this context, “interconnectable with itself” means that the contacting element can be connected to an identically configured contacting element. In the case of a coaxial connector, this means that the contacting element has or replaces both a plug and a socket, and only one part, namely the contacting element, is required to establish the plug connection. The plug-side end of the mating connector, i.e. the identical contacting element, can be opposite the first contacting element and rotated relative to the center axis by mirroring the contacting element relative to a mirror plane that runs perpendicular to the plug-in direction. The mating connector can therefore be another, in particular identical, contacting element that is mirrored and rotated relative to the first contacting element.

Contacting elements configured in this way are referred to as gender-neutral, hermaphroditic, and/or genderless.

When plugged together with another contacting element, the plug-side ends can face each other along the center axis.

The cable-side end opposite the plug-side end can be configured to be connected to a coaxial cable.

In one embodiment, the contacting element can be configured to be plugged together with another contacting element, wherein the other contacting element can comprise at least one identical plug-side end.

Consequently, the plug-side end of the contacting element can be configured to be plugged together with an identical plug-side end of a further contacting element. The identical plug-side end of the further contacting element can be rotated relative to the first plug-side end about the center axis for plugging together.

The contacting element may further be configured such that, in the plugged-in state, the primary lamellae and the secondary lamellae overlap with the primary and secondary lamellae of the identical further contacting element in the radial direction. The lamellae of the contacting element can thus be covered or overlaid by the lamellae of the further contacting element, the counter-lamellae, in the plugged-in state, and vice versa. The following descriptions of the lamella and counter-lamella also apply accordingly to the reverse case, whereby the descriptions of the lamellae, primary lamellae, and secondary lamellae are of course also transferable to the counter-lamellae. In an advantageous embodiment of the contacting element, a connecting seam that is created during the manufacture of the contacting element can be offset from the center axis in the radial direction in order to obtain as uninterrupted a contact surface as possible for the lamella when two lamellae overlap.

The lamellae of the first contacting element and the counter-lamellae can lie radially next to each other or directly on top of each other, or they can be spaced apart radially from the center axis.

In one embodiment, the lamellae of the first contacting element can interlock with the counter-lamellae of the further contacting element to ensure a secure plug connection.

In the text, “below” is defined as a position that is closer to the center axis of the contacting element than the position being compared. Accordingly, “above” refers to a position that is further away from the center axis of the contacting element than the position being compared.

The lamellae of the first contacting element can be located or arranged above the counter-lamellae of the further, in particular identical, further contacting element. The lamellae can be arranged cumulatively or alternatively below the counter-lamellae of the further contacting element. For example, the primary lamellae of the contacting element can be arranged above the secondary lamellae of the further contacting element when connected.

For better contact between the primary lamella of the first contacting element and the secondary lamella of the further contacting element, the lamellae of a contacting element, at least one lamella arrangement of a contacting element, may comprise a contact point that can be bent toward the counter-lamella arranged directly in the radial direction. In particular, the contact point may comprise a projection that protrudes in the radial direction toward the lamellae of the further contacting element. In the embodiment of the contacting element with four identical and elastically configured lamellae, the contact points of the first contacting element may be offset from the contact points of the further contacting element, in particular in the plug-in direction. In another embodiment, the contact points may interlock to ensure a reliable electrical connection.

In the following, the word “inside” is used to define an alignment towards the center axis and “outside” a direction pointing away from the center axis, in particular “outside” refers to the surface of the contacting element that points away from the center axis in the radial direction and, correspondingly, “inside” refers to the surface of the contacting element that points towards the center axis in the radial direction.

The projection may protrude in the radial direction toward the counter-lamella of the other contacting element. Thus, the projection can protrude either inward toward the center axis or outward away from the center axis, depending on whether the lamella of the first contacting element contacts the counter-lamella of the further contacting element from the outside or from the inside relative to the center axis, or is arranged below or above the counter-lamella.

The lamellae can be smooth or flat and can be an extension of the outer sides of the contacting element along the center axis. Furthermore, the lamellae can be formed on two opposite sides of the contacting element with a square cross-section. This results in more overlap of the lamellae, for example, of the rigid and flexible lamellae. This improves the contact coverage and allows the contact bridge to be configured shorter.

The lamellae with projections may be configured to be elastic. The projection may be formed by the ends of elastic lamellae. The ends of the elastic lamellae may be bent away from or toward the center axis at an angle to the center axis.

At least one lamella of the contacting element can be configured to be elastically deflectable. At least one lamella of the contacting element can be configured to be rigid. The at least one lamella with the projection or the contact point can be configured to be resilient. In the radial direction, the at least one elastic lamella can press against the counter-lamella of the further contacting element when the contacting elements come into contact with each other. The at least one lamella can therefore be elastically deflectable in the radial direction. The restoring force of this resilient lamella can ensure sufficiently strong contacting between the two contacting elements.

Furthermore, the lamellae of the contacting element may comprise chambers for the counter-lamellae of the further contacting element. The lamellae may receive counter-lamellae of the further, identical contacting element therein. For example, the primary lamellae of the contacting element may comprise chambers for elastically configured secondary lamellae of the further contacting element.

The chamber of a lamella may be arranged inside the contacting element, whereby the interior may be bound by the outer circumference and the outer walls of the contacting element. The lamellae, which are rigidly configured, may bind the chambers in the radial direction and be arranged above the elastically configured counter-lamellae.

If the lamellae are rigidly configured, for example as jaws, the rigid lamellae can elastically deflect, for example radially inwards or outwards, when the elastically configured counter-lamellae of the further contacting element are inserted. This ensures continuous contact between the rigid lamella and the elastic counter-lamella of the further contacting element after they have been plugged together.

In the embodiment with more than two lamellae, the contacting element can, for example, comprise a total of four elastic lamellae and two rigid lamellae arranged perpendicular to the elastic lamellae. The four elastic lamellae can be arranged so that two are opposite each other on the outer circumference. The lamellae can lie with a flatter side on a plane parallel to the center axis. At least one flat side can point in the radial direction from the center axis.

The contacting element may further comprise primary lamellae having at least one step which protrudes radially away from the center axis beyond the secondary lamellae or vice versa. This achieves a stepped design. The configuration as a step may serve to protect the thinner elastic lamellae of the second lamella arrangement.

The lamellae of the first lamella arrangement and the lamellae of the second lamella arrangement may be configured or shaped differently.

For example, the primary lamellae may comprise a different stiffness than the secondary lamellae. Furthermore, the primary lamellae may be longer than the secondary lamellae. In one embodiment, the primary lamellae may be wider than the secondary lamellae. In another embodiment, all lamellae of the contacting element may be identical or have similar dimensions.

The contacting element can be configured as an outer contact for the contact assembly for coaxial connectors.

The outer contact may be configured to be connected to an outer conductor of the coaxial cable. The outer contact thus assumes the function of the outer conductor within the contact assembly.

The contacting element may be configured as an inner contact for the contact assembly for coaxial connectors. The inner contact may be made from a stamped and bent part. In the rotationally symmetrical embodiment, a contacting element may also be rotated.

The inner contact may be configured to be connected to an inner conductor of the coaxial cable. The inner contact thus assumes the function of the inner conductor within the contact assembly. The inner contact may be crimped to a cable or an inner conductor with a ferrule at the cable-side end opposite the plug-in direction.

The contact assembly may comprise an inner contact. The contact assembly may comprise an outer contact, in particular arranged coaxially with the inner contact. Furthermore, the contact assembly may comprise an insulating body arranged coaxially with the inner contact and/or outer contact.

The contact assembly can contact an identical contact assembly and be configured to be plugged together with the identical contact assembly.

The lamellae of the outer contact, the outer lamellae, may cover the lamellae of the inner contact, the inner lamellae, radially to the center axis. In one embodiment, the outer lamellae may be longer than the inner lamellae.

The insulating body can separate the inner and outer contacts spatially and electrically from each other. The insulating body insulates the outer and inner contacts from each other and functions similarly to the dielectric of a coaxial cable. The insulating body can be arranged between the inner contact and the outer contact, particularly in the radial direction.

The insulating body can comprise a lamella arrangement with at least two lamellae, the insulation lamellae, which are radially opposite each other with respect to a center axis of the contacting element.

The insulating body may comprise pockets in which lamellae of the outer contact are received. At least one lamella arrangement of the outer contact may be received in the pockets. An insulation lamella may comprise two pockets, for example for two lamellae arranged next to each other on one side of the outer contact.

The insulating body may furthermore comprise receptacles for the counter-lamellae of the further insulating body of the further contact assembly, so that unintentional rotation of the contact assembly about the center axis can be prevented.

The insulation lamellae can protrude beyond the inner lamellae along the center axis. Alternatively, the insulation lamellae can be of equal length or shorter. Furthermore, the insulation lamellae can be wider than the outer and/or inner lamellae. The outer lamellae can protrude beyond the inner lamellae and/or the insulation lamellae along the center axis.

The lamellae of the insulating body and the outer contact can protrude beyond the lamellae of the inner contact along the center axis in the plug-in direction.

In one embodiment, rigidly configured primary lamellae of the outer contact may be arranged directly above elastically configured secondary lamellae of the inner contact.

The insulation lamellae of the insulating body may comprise flat sides that point in the radial direction. The flat sides of the insulation lamellae may be arranged perpendicular to the flat sides of the outer lamellae.

In a further embodiment, at least one contacting element and/or the contact assembly, in particular the plug-side end of the contact assembly and/or the at least one contacting element, may be configured to be connectable to a conventional, non-hermaphroditic contact, in particular a contact for any specified interface. This specified interface does not itself have to be of a hermaphroditic design, so that the contact and/or a plug connector of the specified interface does not have to be identical in design to the contacting element and/or the contact assembly. For example, the specified interface may be an interface specified by the customer or manufacturer, or an interface of an already installed plug device.

The contact of the specified interface can, for example, protrude in the form of a pin or stud toward the contacting element and/or the contact assembly. The contact of the specified interface can be arranged coaxially with the inner contact along the center axis and opposite the contact assembly and/or the contacting element, for example, the inner contact. The contact of the specified interface can be part of a connector, in particular, the contact can be part of a connector of a specified interface as mentioned above. A further embodiment provides for a contact configured as a socket.

When the connector is mated with the contact of the specified interface and the contact assembly, the lamellae of the inner contact can contact the contact of the specified interface. For example, the lamellae of the inner contact can surround the contact of the specified interface when fully mated. The lamellae of the inner contact can grip the contact of the specified interface. For example, two opposite lamellae of the inner contact, for example the primary lamellae of the inner contact, can touch the contact of the specified interface and make electrical contact with it. The secondary lamellae can be spaced apart from the contact of the specified interface in one embodiment.

If the contact of the specified interface is configured as a socket and/or with a sleeve, the contacting element, for example the outer contact, can contact the socket or sleeve with a lamella arrangement from the outside, i.e. on the side facing away from the center axis. The further lamella arrangement can contact the contact of the specified interface from the inside, i.e., on the side facing the center axis.

Furthermore, the contact assembly may comprise an outer housing that surrounds the outer contact, inner contact, and/or insulating body. The outer housing may be locked with a locking element that is arranged on the outer circumference of the outer contact. Furthermore, the outer housing can be locked with the same locking element or another locking element with an outer housing of another contact assembly. Thus, the outer housing can lock the contact assembly with another, in particular identical, contact assembly.

The locking element may be a groove or a locking lug.

For orientation within an outer housing and to prevent free rotation within the outer housing, a stop can be attached to the contacting element. In particular, the stop can be arranged on the contacting element of the contact assembly that is positioned furthest out, for example on the outer contact. The stop can counteract a pull-out force in the axial direction, opposite the plug-in direction, and mechanically fixes the contact assembly in the outer housing.

The contact assembly, e.g., the insulating body and/or the outer contact, may comprise insertion chamfers to guide the opposite contact assembly for correct insertion.

The contact assembly can be part of a contact arrangement that contains a contact assembly as described above and a connector with a contact of a specified interface as described above. When mated, the contact assembly and connector can establish an electrical connection with the contact of the specified interface. The electrical connection can be made in particular by contacting the lamella arrangement(s) of the inner and/or outer contact with the contact of the specified interface.

In an embodiment, a set is provided comprising a plurality of contact assemblies as described above, wherein the plug-side ends of the contact assemblies are configured identically and the lamellae of the first contact assembly are arranged between the lamellae of the further contact assembly when in a plugged-in state.

In this way, the lamellae of the further contact assembly can be arranged in the circumferential direction between the lamellae of the first contact assembly.

The contact assemblies can be configured to be connected together in at least one position along the center axis. For example, the other contact assembly can be offset by 90° relative to the first contact assembly. The contact assemblies can also be plugged together in two positions. The two positions can be offset by 180°. A coding can be added so that the contact assemblies can only be plugged together in certain positions. The further, in particular identical, contact assembly can be oriented along the circumferential direction around the center axis offset to the first contact assembly.

The plug-side ends of two contact assemblies in the plugged-in state can face each other along the center axis. The lamellae of the inner contact and/or the outer contact of the first contact assembly can overlap with the lamellae of the inner and/or outer contact of the further, identical contact assembly.

The outer lamellae of the outer contact can contact the outer contact of a further identical contact assembly from the inside. The outer contour of the plug connection between the first contact assembly and the further contact assembly can be flat when plugged together. This enables a compact design and a simplified design basis for the outer housing.

When plugged together, the rigid outer lamellae can cover the elastic outer lamellae from the outside. In addition, the elastic inner lamellae can, for example, cover the rigid inner lamellae of the second contact assembly.

When plugged together, the lamellae of the contact assembly can slide over the surface, in particular over the surfaces of the respective lamellae of the other contact assembly. This allows rigid lamellae to be arranged under the elastic lamellae of the other contact assembly. For example, rigid inner lamellae can slide under the elastic inner lamellae of the other contact assembly and rigid outer lamellae can slide over the elastic inner lamellae.

The contact assemblies can be arranged parallel to each other in the cross-sectional plane in a grid, for example in a 2×1 or 2×2 grid.

In order to prevent incorrect insertion, the contact assemblies, in particular the outer housings, may comprise variably configured grooves and/or ribs. Each contact assembly may comprise identically configured grooves and/or ribs which can only engage with each other in a specific position when mirrored and rotated.

The subject matter herein is described below with reference to the drawings using an example of embodiment. In the drawings, the same reference symbols are always used for elements that correspond to each other in terms of function and/or structure.

In accordance with the above description, a feature of the embodiment may be omitted if, in a particular application, the technical effect associated with this feature is not relevant. Conversely, a feature not yet present in the embodiment may also be added in accordance with the above description if the technical effect of the feature to be added is important for a particular application.

### BRIEF DESCRIPTION OF THE DRAWINGS

FIG. 1 a schematic representation of an embodiment of the contacting element;

FIG. 2 a schematic representation of a further embodiment of the contacting element;

FIG. 3 a schematic representation of an embodiment of the contacting element with a cable;

FIG. 4 a schematic representation of an embodiment of the contacting element with a further contacting element;

FIG. 5 a schematic representation of a further embodiment of the contacting element with a further contacting element;

FIG. 6 a schematic representation of an embodiment of the contacting element in a plugged-in state with a further contacting element;

FIG. 7 a schematic representation of a further embodiment of the contacting element in the plugged-in state with a further contacting element;

FIG. 8 a schematic representation of an embodiment of a contact assembly;

FIG. 9 a schematic representation of an embodiment of the insulating body;

FIG. 10 a schematic representation of an embodiment of the insulating body with receptacles;

FIG. 11 a schematic cross-sectional representation of an embodiment of the set in the plugged-in state;

FIG. 12 a schematic representation of an embodiment of the set;

FIG. 13 a schematic cross-sectional view of an embodiment of the contact assembly;

FIG. 14 a schematic representation of a further embodiment of the set;

FIG. 15 a schematic representation of an embodiment of the contact assembly;

FIG. 16 a schematic representation of an embodiment of a contact arrangement in an unassembled state; and

FIG. 17 a schematic representation of an embodiment of a contact arrangement in the plugged-in state and a sectional view of this embodiment.

### DETAILED DESCRIPTION OF THE INVENTION

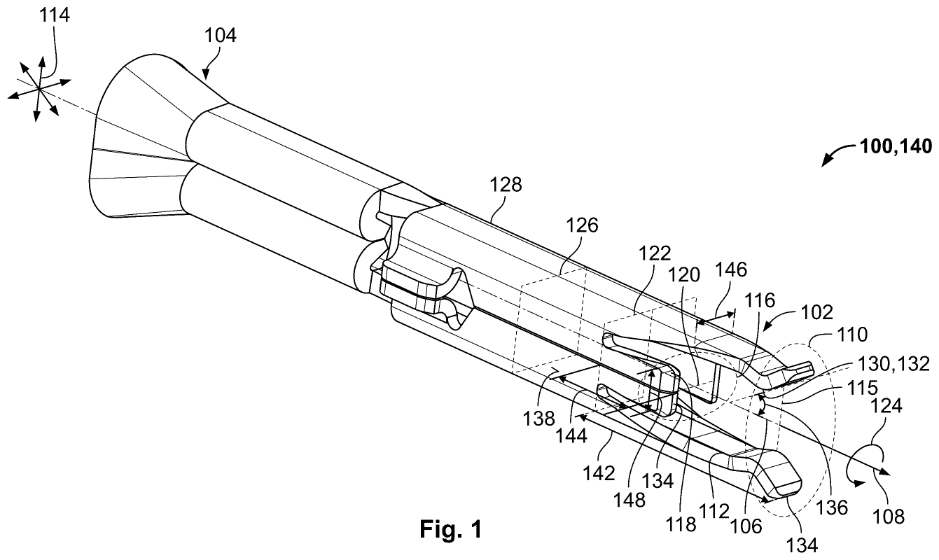

FIG. 1 shows a contacting element 100. The contacting element 100 has a plug side end 102 and a cable side end 104 opposite this plug side end 102.

The contacting element 100 extends from the cable-side end 104 along a center axis 106 to the plug-side end 102 in a plug-indirection 108. The plug-side end 102 comprises a first lamella arrangement 110. A first lamella arrangement 110 in turn comprises primary lamellae 112. The primary lamellae 112 are radially opposite each other with respect to the center axis 106, i.e., they are opposite each other along a straight line 115 running in a radial direction 114, which runs through both primary lamellae 112 and is perpendicular to the center axis 106.

The contacting element 100 further has a second lamella arrangement 116 with secondary lamellae 118, which are opposite each other along a straight line 120 running in the radial direction 114.

The primary lamellae 112 and the secondary lamellae 118 can be arranged around the center axis 106 along a circumferential direction 124 extending around the center axis 106 on a cross-sectional plane 122 having the center axis 106 as its normal.

The primary lamellae 112 and the secondary lamellae 118 may be arranged at the plug-side end 102 of the contacting element 100.

The second lamella arrangement 116 is offset from the first lamella arrangement 110 in the circumferential direction 124.

The contacting element 100 may comprise a polygonal cross-section 126.

In total, the contacting element 100 in FIG. 1 has four lamellae 112, 118.

The primary lamellae 112 may be arranged diametrically, i.e., at two opposite points of the cross-section 126 that are furthest apart.

The secondary lamellae 118 may also be arranged diametrically, so that the lamellae 118, 112 are equidistant from each other along the circumferential direction 124.

The radial line 120 of the lamellae of the second lamella arrangement 116 may intersect the radial line 114 of the first lamella arrangement 110.

The center axis 106 and the plug-in direction 108 may run parallel.

The contacting element 100 may be configured to be cuboid. In an alternative embodiment, the contacting element 100 may be configured to be rotationally symmetrical or cylindrical.

The primary lamellae 112 and the secondary lamellae 118 may protrude along the center axis 106 from the plug-side end 102, the secondary lamellae 118 and the primary lamellae 112 may extend along the center axis 106 from the plug-side end 102 away from the rest of the contacting element 100.

The lamellae 112, 118 may be arranged or formed on an outer circumference 128 of the contacting element 100.

In one embodiment, the contacting element 100 may comprise the first lamella arrangement 110 and the second lamella arrangement 116, each of which has two opposing lamellae 112, 118. In the circumferential direction 124, the primary lamellae 112 may be arranged alternately with the secondary lamellae 118. Starting from a primary lamella 112, the contacting element 100 may comprise a secondary lamella 118 in the circumferential direction 124 and then another primary lamella 112 opposite the first primary lamella 112. In the circumferential direction 124, a secondary lamella 118 is thus located between two primary lamellae 112.

The lamellae 112, 118 may comprise contact points 130 or projections 132 which point in the radial direction 114 towards the center axis 106. Alternatively, the projections 132 may point away from the center axis 106.

The primary lamellae 112 and the secondary lamellae 118 may be configured or shaped differently. The primary lamellae 112 and the secondary lamellae 118 may comprise different degrees of rigidity. For example, the primary lamellae 112 may be configured to be elastic. The secondary lamellae 118 may be configured to be rigid.

In particular, the primary lamellae 112, which are configured to be elastically deflectable, can be elastically deflectable, flexible, or resilient in the radial direction 114, for example, along the radial straight line 115.

The projection 132 may protrude inward, i.e., toward the center axis 106, or outward from the center axis 106 in the radial direction 114.

The ends 134 of the primary lamellae 112 or secondary lamellae 118 may be bent at an angle 136 to the center axis 106.

The two opposing lamellae 112, 118 may be configured in a fork shape.

One embodiment of the lamellae 112, 118 is a smooth or flat configuration, such as the secondary lamellae 118 in FIG. 1. For example, the second lamella arrangement 116 may form an extension of the outer sides 138 of the contacting element 100. With the square cross-section 126, the lamellae 112, 118 can, for example, be formed by two opposite outer sides 138 of the contacting element 100.

The contacting element 100 can be configured as an inner contact 140 for a contact assembly, for example for coaxial connectors. The inner contact 140 takes on the properties of the inner conductor of a coaxial cable, for example for transmitting signals and/or current.

The inner contact 140 can be made from a stamped and bent part. The contacting element 100 can be made from a stamped and bent part or can be turned if, for example, a rotationally symmetrical configuration is desired.

The primary lamellae 112 may be longer than the secondary lamellae 118. For example, a primary lamella may comprise a length 142 extending from the plug-side end 102 away from the rest of the contacting element 100. The secondary lamella 118 may, for example, comprise a shorter length 144, which is also measured from the plug-side end 102 along the center axis 106.

Similarly, the primary lamella 112 may comprise a width 146 that is less wide than the width 148 of a secondary lamella 118. In another embodiment, the width 146 of the primary lamella 112 may be wider than the width 148 of the secondary lamella 118. In a further embodiment, both lamellae arrangements 110, 116 comprise the same width 146, 148. The same applies to the length 142, 144.

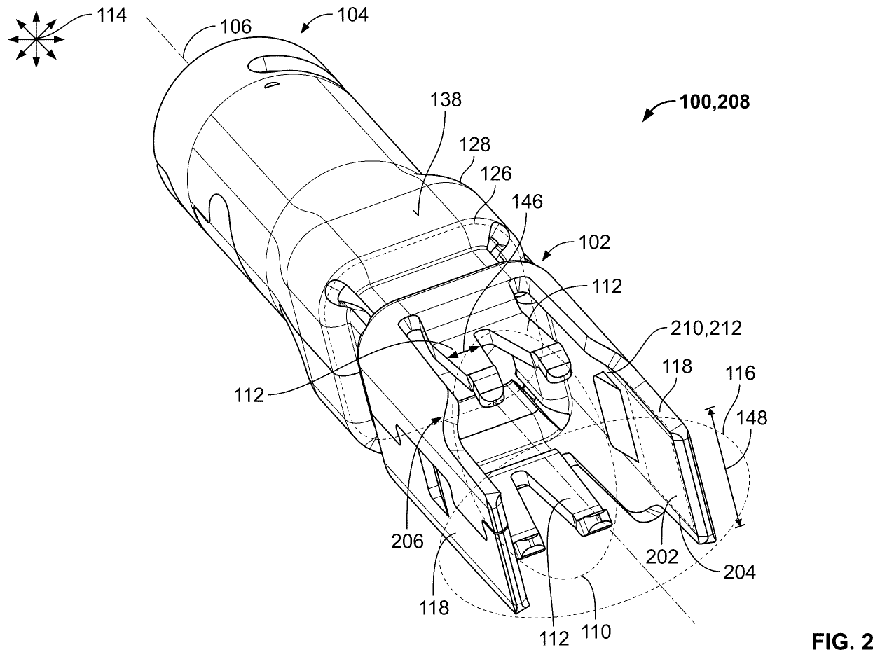

FIG. 2 shows an embodiment of the contacting element 100, also with a plug-side end 102 and a cable side end 104. The contacting element 100 of FIG. 2 has a first lamella arrangement 110 with lamellae 112 and a second lamella arrangement 116 with lamellae 118.

The contacting element 100 of FIG. 2 has an almost square cross-section 126. In this embodiment, the lamellae 118 of the second lamella arrangement 116 are wider, with a greater width 148 than the lamellae 112 of the first lamella arrangement 110.

The first lamella arrangement 110 can comprise two lamellae 112 on each outer side 138. The two lamellae 112 arranged next to each other can be opposed by two further lamellae 112 in the radial direction 114. In total, the contacting element 100 can thus comprise four elastic lamellae 112 and two rigid lamellae 116, as shown in FIG. 2. The secondary lamellae 118 can point with their flatter side 202 in the radial direction 114. For example, the secondary lamellae 118 can lie with their flatter side 202 on a plane 204 that is parallel to the center axis 106. A flat side 202 may face in the radial direction 114 toward the center axis 106. In this embodiment, the lamellae 112 of the first lamella arrangement 110 comprise projections 132 that are curved outward, i.e., away from the center axis 106.

The lamellae 118 of the second lamella arrangement 116 may comprise shoulders 206 that protrude along the plane 204 in a radial direction 114 away from the center axis 106. The shoulders 206 may protrude beyond the primary lamellae 112 along the plane 204 and/or along the radial direction 114. Of course, this may also apply vice versa, so that the first lamella arrangement 110 has shoulders that protrude beyond the lamellae of the second lamella arrangement 116.

The secondary lamellae 118 may be configured as a step to protect the thinner primary lamellae 112 of the first lamellae arrangement 110.

The contacting element 100 may be configured as an outer contact 208 for a contact assembly for coaxial connectors.

The outer contact 208 can assume the function of the outer conductor of a coaxial cable and serve to shield the inner conductor or the inner contact 140 (FIG. 1).

The secondary lamellae 118 may also comprise chambers 210. These chambers 210 may receive, for example, a primary lamella of a further contacting element.

The chamber 210 can be located on the inside 212 of the contacting element 100. This means that the inside 212 is bound by the outer circumference 128 of the contacting element 100 or by the outer sides 138 of the contacting element 100. In one embodiment, the rigid secondary lamellae 118 can bind the chambers 210.

The lamellae 118, 112 may be elongated and plate-shaped.

The contacting element 100 may be configured as both an inner contact 140 and an outer contact 208, for example for a coaxial connector.

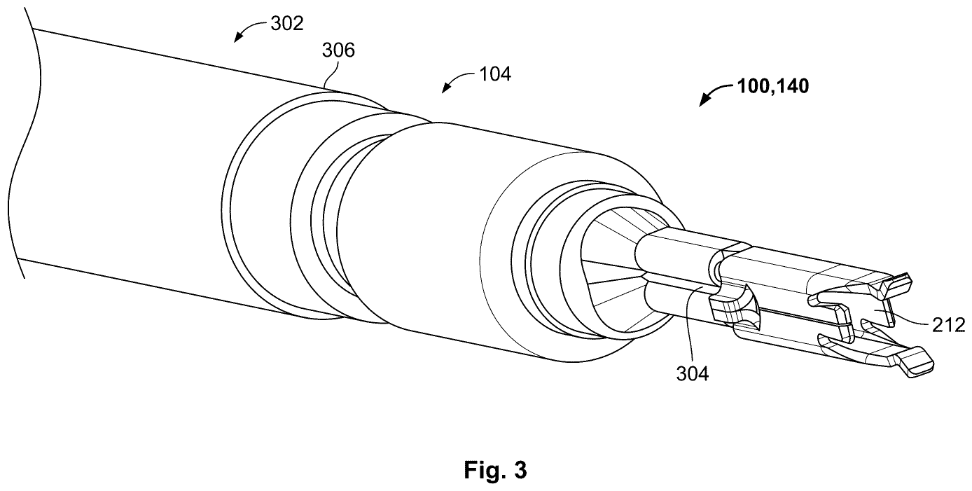

FIG. 3 shows an embodiment of the contacting element 100, wherein the contacting element 100 may be configured as an inner contact 140.

The cable-side end 104 may be configured to be connected to a coaxial cable 302.

The contacting element 100 may, for example, be connected to the cable 302 by crimping. An inner conductor 304 of the cable may be connected directly to the inside 212 of the contacting element 100. The cable braid can be slipped over the cable-side end 104, for example via a ferrule, of the contacting element 100, and a cable insulation 306 can be stripped back to just before the cable-side end 104 of the contacting element 100.

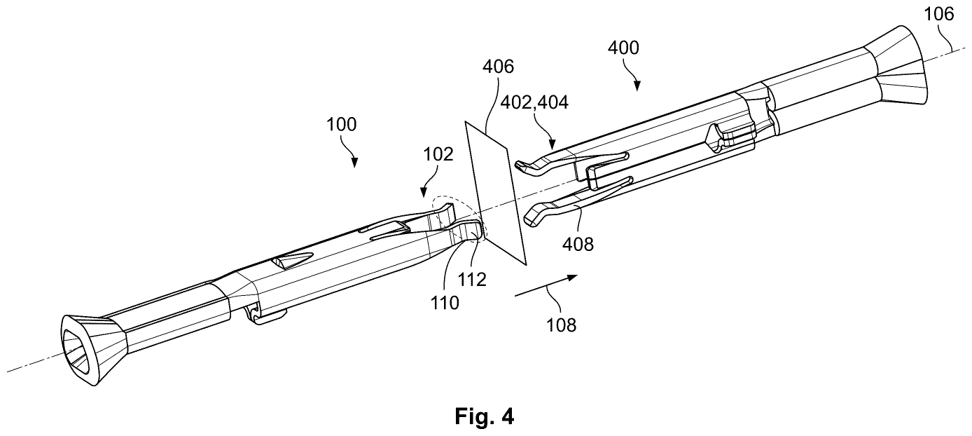

FIG. 4 shows a contacting element 100 with a further contacting element 400. The contacting element 100 and the further contacting element 400 are located opposite each other along the center axis 106 with plug-side ends 102, 402. The contacting element 100 is configured to be plugged together with the additional, in particular identical, contacting element 400 along the plug-in direction 108. For example, the contacting element 100 can be part of a coaxial plug connector in the automotive sector. The contacting element 100 can therefore be configured to be plugged together with itself, especially along a plug-in direction 108. The contacting element 100 can thus be gender-neutral or hermaphroditic or genderless.

The contacting element 100 can be configured in particular to receive an identical contacting element 400, at least in sections, for example a plug-side end 404 of the identical contacting element 400. The plug-side end 404 can be arranged at the plug-side end 102.

The identical contacting element 400 may be mirrored to the first contacting element 100 at a mirror plane 406 having the center axis 106 as its normal and rotated about the center axis 106. In one embodiment, the identical contacting element 400 may only have an identical plug side end 402, and the rest of the contacting element 400 may be configured differently.

The plug-side end 102 may be configured to be pluggable with the identical plug-side end 402 of the further contacting element 400. The identical plug-side end 402 may be rotated relative to the first plug-side end 102, particularly with respect to the center axis 106, so that the primary lamellae 112 of the contacting element 100 are rotated 90 degrees relative to the primary lamellae 408.

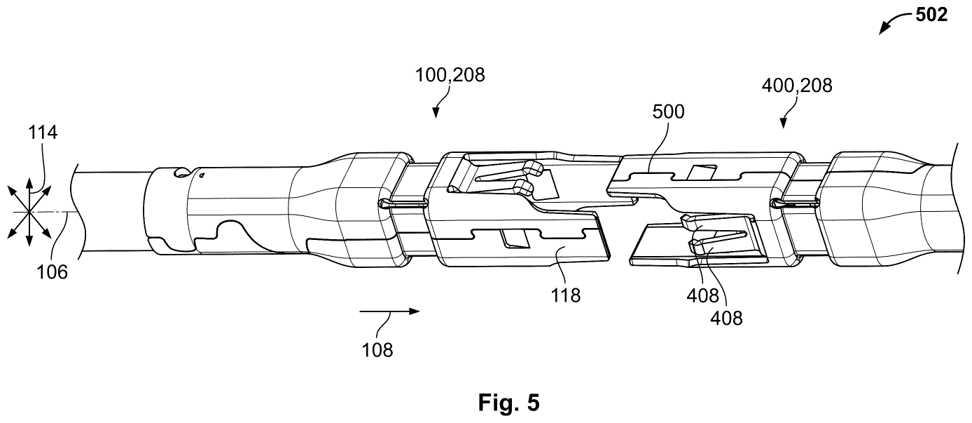

FIG. 5 shows a further embodiment of a contacting element 100 with a further contacting element 400.

The contacting elements 100, 400 may each be configured as an outer contact 208.

When plugged together, the secondary lamellae 118 of the contacting element 100 can slide over the primary lamellae 408 of the other contacting element 400. The secondary lamellae 118 can be rigidly configured, and can press the primary lamellae 408 of the further contacting element 100 inwards in the radial direction 114, i.e. towards the center axis 106, when the contacting elements 100, 400 come into contact with each other. The restoring force of the elastically deflectable primary lamellae 408 of the further contacting element 400 can thereby ensure sufficiently strong contact and press outwardly away from the center axis 106 onto the respective secondary lamella 118, in particular onto the inner flat side of the secondary lamella 118.

In another embodiment, the rigid lamellae are located under the elastic lamellae when plugged together, and the outer lamellae are deflected elastically outwards away from the center axis 106. The restoring force then acts inwards towards the center axis 106.

When assembled, the lamellae 112, 118 of the contacting element 100 can overlap with the lamellae 408, 500 of the further contacting element 400 in the radial direction 114.

The secondary lamellae 118 and the primary lamellae 408 of the further contacting element 400 can lie against each other and lie directly on top of each other in the radial direction 114. In another embodiment, they can be spaced apart from each other in the radial direction 114 at least in sections. In a further embodiment, the lamellae 112, 118 of the first contacting element 100 can jam with the lamellae 408, 500 of the second contacting element 400.

The lamellae 112, 118 of the first contacting element 100 may be located below and/or above the lamellae 408, 500 of the further contacting element 400.

In FIG. 5, the contacting element 100 and the further contacting element 400 are spaced apart from each other in a pre-mating position 502 along the center axis 106. Movement of the contacting element 100 in the mating direction 108 would connect the two contacting elements 100, 400 to each other.

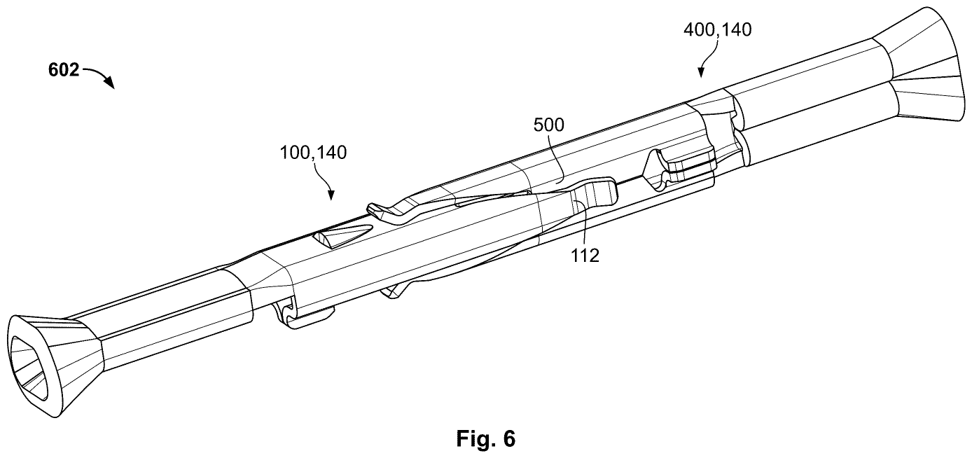

FIG. 6 shows a contacting element 100 in a plugged-in state 602 with a further contacting element 400. The elastic primary lamellae of the first contacting element 100 slide over the secondary lamellae 500 of the further contacting element 400. The contacting elements 100, 400 shown in FIG. 6 can each be configured as an inner contact 140.

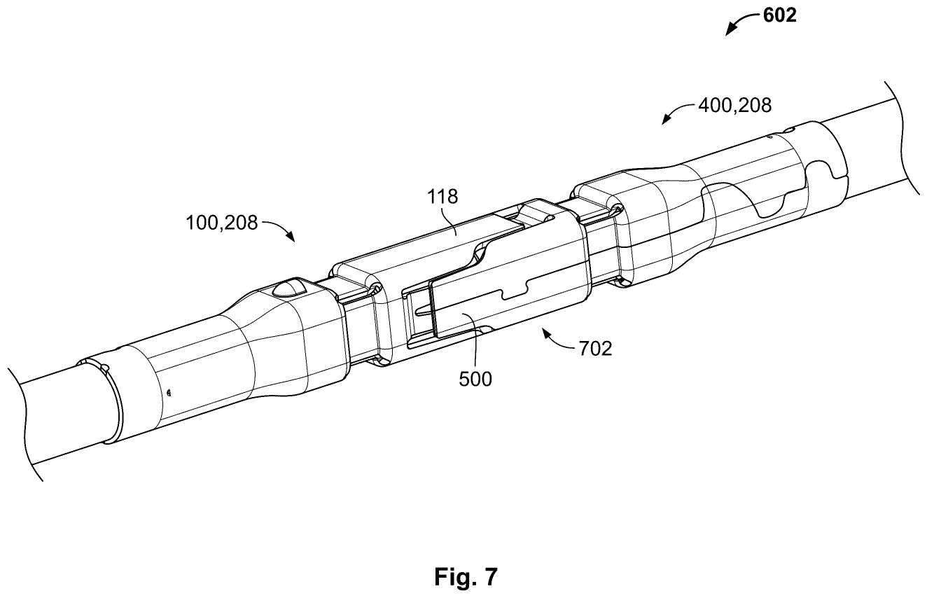

FIG. 7 shows a plugged-in state 602 of two contacting elements 100, 400, which are configured as outer contacts 208. In this embodiment, the rigidly configured secondary lamellae 118, 500 are visible from the outside and enclose the inside 212 between them. The outer contour 702 can be flat in the plugged-in state 602. This facilitates the housing design of the subsequent connector. In the plugged-in state, the secondary lamellae 118 can cover the elastic primary lamellae 408 of the other contacting element 400 for a compact design.

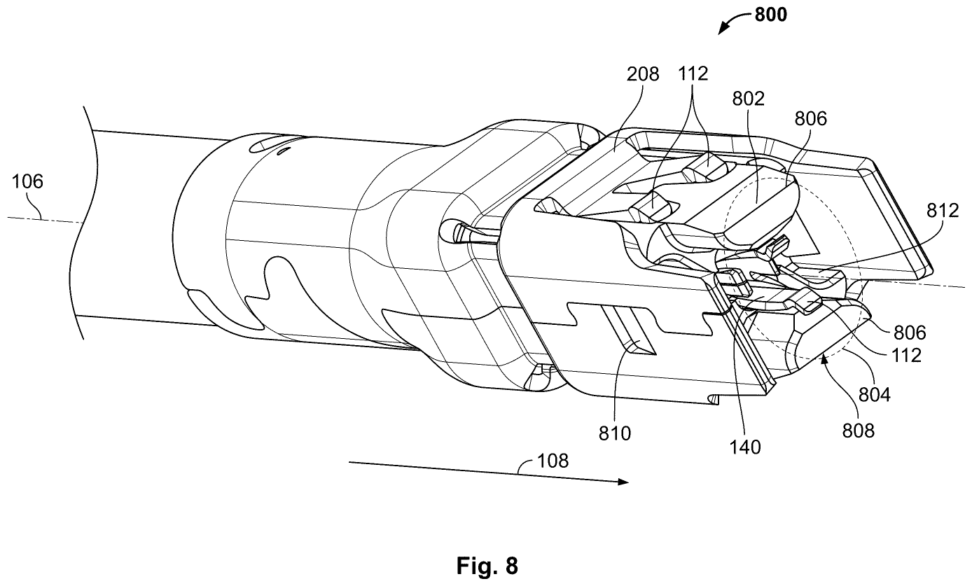

FIG. 8 shows a contact assembly 800. The contact assembly 800 may include an inner contact 140 and an outer contact 208. Furthermore, the contact assembly 800 may have an insulating body 802. The inner contact 140 may be arranged coaxially with the outer contact 208. The insulating body 802 may also be arranged coaxially with the inner contact 140 and/or the outer contact 208. The contact assembly 800 can be configured to be plugged together with an identical contact assembly, i.e., to be pluggable with itself. The contact assembly 800 can therefore contact an identical contact assembly. In particular, the contact assembly 800 can contact another contact assembly with an identical plug-side end 102.

In the radial direction 114, the lamellae of the outer contact 208 cover the lamellae of the inner contact 140.

The insulating body 802 can be a dielectric, i.e., a non-conductor. The insulating body 802 may be arranged in the radial direction 114 between the inner contact 140 and the outer contact 208. The insulating body 802 insulates the outer contact 208 and the inner contact 140 from each other and separates them spatially and electrically from each other.

The insulating body 802 may have a lamellar arrangement 804. The lamella arrangement 804 of the insulating body 802 may have at least two lamellae 806 that are radially opposite each other with respect to the center axis 106 of the contacting element 100. The lamellae 806 may be configured like the lamellae 118, 112 of the contacting element 100, for example in the form of plates with a flat side 808 pointing in the radial direction 114, for example in the same radial direction 114 as the primary lamellae 112 of the inner contact 140. The lamellae 806 of the insulating body 802 may be arranged perpendicular to the flat sides of the secondary lamellae of the outer contact 208.

The lamellae 806 of the insulating body 802 may be longer and/or wider than the lamellae of the inner contact 140 and/or the outer contact 208, as required. Other embodiments provide for lamellae 806 of the insulating body 802 that are narrower and/or shorter than the lamellae of the inner contact 140 and/or the outer contact 208. The insulating body 802, in particular the lamellae 806 of the insulating body 802, may protrude beyond the lamellae of the inner contact along the center axis 106 in the insertion direction 108. In a further embodiment, the lamellae of the outer contact 208 may protrude beyond the lamellae of the inner contact 140 along the center axis 106. The lamellae of the outer contact 208 may also protrude beyond the lamellae of the insulating body 802.

The contact assembly 800 may further comprise a locking element 810, with which an insulating body can be fixed and, for example, locked into an outer housing. The locking element 810 may be an embossing or a locking tab.

This locking element 810 can also be used for orientation within an outer housing, and in a rotationally symmetrical embodiment, free rotation within the outer housing can be prevented. The locking element can thus also be used as a stop that mechanically fixes the contact assembly 800 in the axial direction in the outer housing. Furthermore, the assembly 800 may have insertion chamfers 812, for example on the insulating body 802 and/or the outer contact 208, in order to guide an opposing contact assembly for correct plugging.

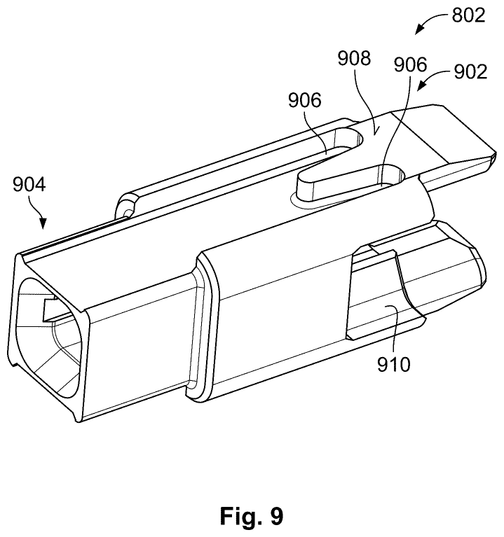

FIG. 9 shows an insulating body 802. The insulating body 802 has a plug-side end 902 and a cable end 904. These ends 902, 904 can be aligned exactly with the ends 102, 104 of the contacting element 100. A dielectric of the coaxial cable 302 can be connected to the insulating body 802 in order to ensure the properties of the dielectric even when the plug connection is made. The insulating body 802 may have pockets 906. Lamellae of the outer contact 208 may be received in these pockets 906. The pocket 906 may be configured on the same outer side 908 as a lamella 806 of the insulating body 802. The pocket 906 may be configured to receive at least one lamella. In this illustration, the pocket 906 can receive two lamellae arranged next to each other. Furthermore, the insulating body 802 may have receptacles 910 in which lamellae 806 of a further insulating body can be received.

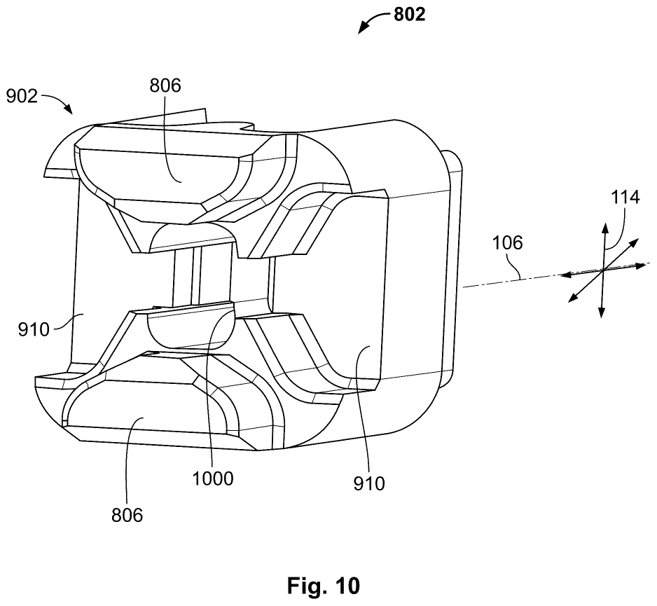

FIG. 10 shows the insulating body 802, in particular the plug-side end 902 of the insulating body. The receptacles 910 can be clearly seen again here. The lamellae 806 are arranged opposite each other in the radial direction. The insulating body 802 may have a through-opening 1000 through which an inner contact 140 can be guided.

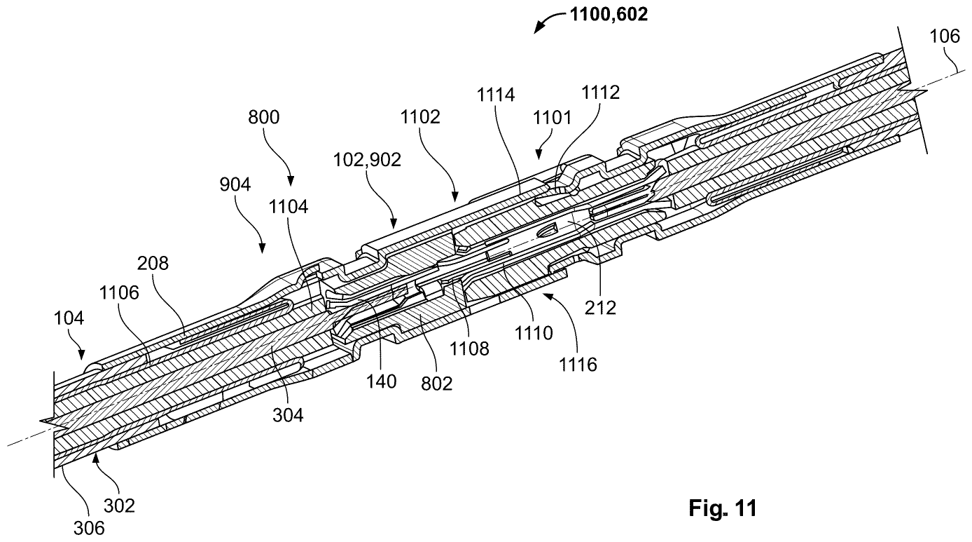

FIG. 11 shows a set 1100 with a contact assembly 800 and another contact assembly 1101 in the plugged-in state 602. The cable-side ends 904, 104 of the contacting elements 100 and the insulating body 802 of the first contact assembly 800 are connected to the cable 302, and the plug-side ends 102, 902 of the contacting elements 100 and the insulating body 802 of the first contact assembly 800 are opposite the plug-side end 1102 of the further contact assembly 1101 along the center axis 106. The inner 1 conductor 304 of the cable 302 is connected to the inner contact 140. A dielectric 1104 of the coaxial cable is connected to the insulating body 802 and separates the inner conductor 304 from an outer conductor 1106 of the coaxial cable. The outer conductor 1106 is connected to the outer contact 208. The cable insulation 306 is slipped over the inner contact 140 and is located between the inner contact 140 and the outer contact 208.

The inner lamellae 1108 of the inner contact 140, which are configured, for example, as rigid, flat primary lamellae, slide under the inner lamellae 1110 of the opposite contact assembly 1101, primarily over the elastic inner lamellae 1110 of the further contact assembly 1101, which are configured with curved ends.

The outer lamellae 1112 of the further contact assembly 1101, which are elastic, slide on the inside 212 under the rigid outer lamellae 1114 of the contact assembly 800.

When assembled, the elastic inner lamellae 1110 of the additional contact assembly 1101 cover the rigid inner lamellae 1108 of the first contact assembly 800. The rigid outer lamellae 1114 of the contact assembly 800 cover the elastic outer lamellae 1112 from the outside. The outer contour 1116 of the entire set 1100 can be flat when in the plugged-in state 602. This enables a compact design.

The set 1100 can contain a plurality of contact assemblies 800. The plug-side ends 1102, 102 of the contact assemblies can be identically configured, and the lamellae 1108, 1114 of the first contact assembly 800 can be arranged between the lamellae 1110, 1112 of the second contact assembly 1101 when in the plugged-in state 602.

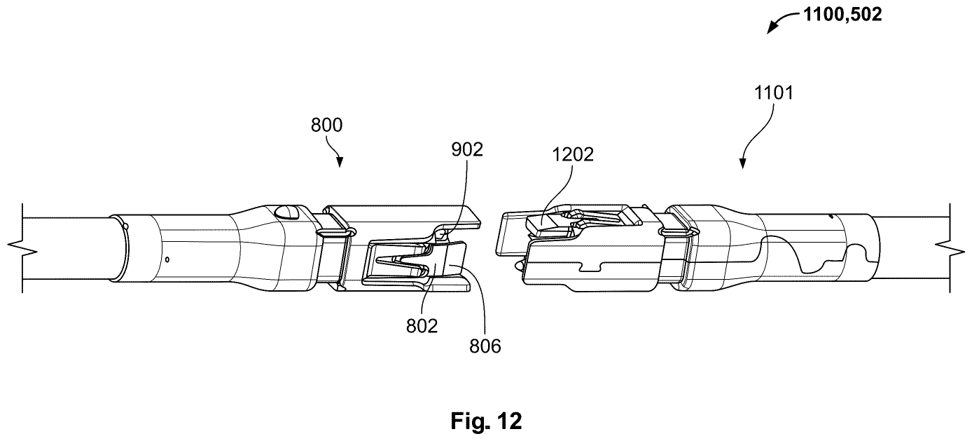

FIG. 12 shows another embodiment of the set 1100 in a pre-mating position 502 shortly before the plugged-in state 602. The lamellae 806 of the insulating body 802 of the first contact assembly 800 can be arranged perpendicular to the lamellae 1202, the counter-lamellae of the insulating body 1204 of the second contact assembly 1101. The lamellae 1202 of the insulating body 1204 of the second contact assembly 1101, also referred to as insulation lamellae 1202, can be received in the receptacles 910 of the insulating body 802 of the first contact assembly 800.

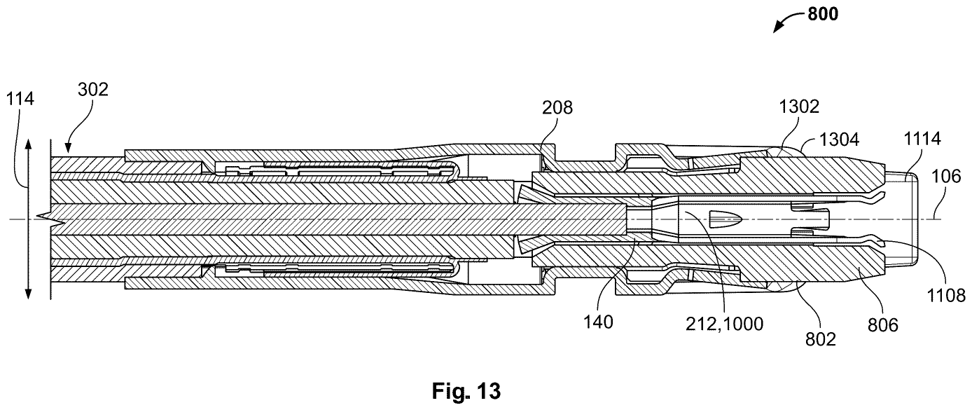

FIG. 13 shows a sectional view of a single contact assembly 800. The outer lamellae 1114 of the outer contact 208 are configured here to be longer than the lamellae 806 of the insulating body 802 and/or the inner lamellae 1108 of the inner contact 140 along the center axis 106. Bent ends 1302 of the outer lamellae 1114 do not protrude beyond the shoulders 1304 of the outer lamellae 1114 in a radial direction 114 perpendicular to the center axis 106. The inner contact 140 is arranged on the inside 212, in particular in the through-opening 1000 of the insulating body 802. All three components, outer contact 208, inner contact 140, and insulating body 802, are coaxially aligned. It can be seen that the outer contact 208 and the inner contact 140 are separated from the insulating body 802. The individual components of the coaxial cable 302 are each connected only to the corresponding components of the contact assembly 800.

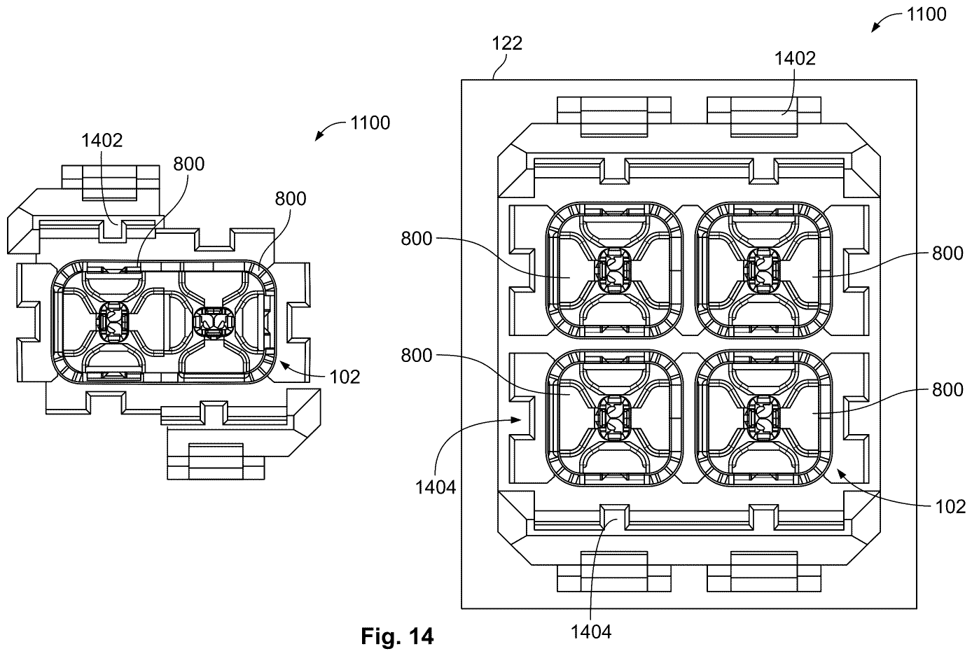

FIG. 14 shows two further embodiments of the set 1100 of contact assemblies 800. This embodiment includes the arrangement of several contact assemblies 800 in a plane, for example a cross-sectional plane 122 or a plane parallel to the cross-sectional plane 122.

The contact assemblies 800 can be arranged next to each other and parallel to the center axis 106. The plug-side ends 102 of the respective contact assemblies 800 can point in the same direction and, for example, point in the direction of plug-in direction 108.

For example, this embodiment can be used for a twisted pair cable, i.e., a cable with, for example, two conductors twisted together and a shield.

In another embodiment, the contact assemblies 800 may be arranged in a grid. For example, the contact assemblies may be arranged in a 2×2 grid, also on the cross-sectional plane 122 or a plane parallel to the cross-sectional plane.

The set 1100 of contact assemblies 800 may be surrounded or enclosed by a single outer housing 1402 and hold the contact assemblies 800 to the outer housing 1402.

The contact assemblies 800 may have latching elements and coding elements 1404 for easy plugging, primarily to simplify assembly and prevent incorrect handling.

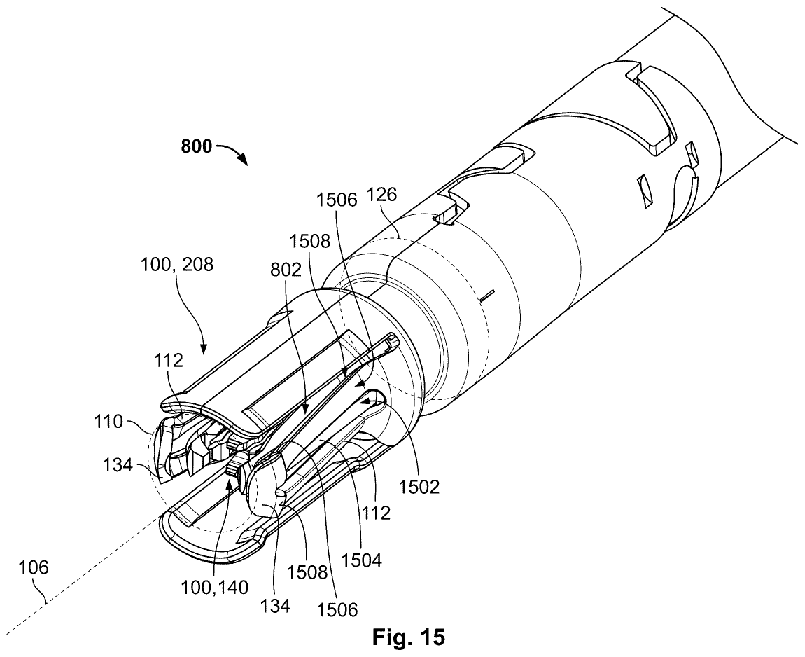

FIG. 15 shows an embodiment of the contact assembly 800 with contacting elements 100 that have a round cross-section 126, i.e., both the outer contact 208 and the inner contact 140 can be round in shape.

The contacting element 100 may have a first lamella arrangement 110 with primary lamellae 112 that have a recess 1502. The recess 1502 may provide space for a projection 1504 of the insulating body 802. For example, this allows the minimum material thickness for forming to be maintained.

The end 134 of the primary lamella 112 may be bent toward the center axis 106. The primary lamella 112 may further have at least one kink or bend 1506. The bend 1506 may face the center axis 106 with the side 1508 that is stretched or bent. An alternative embodiment can be seen at the end 134 of the primary lamella 112, in which the bent side 1508 may face away from the center axis 106.

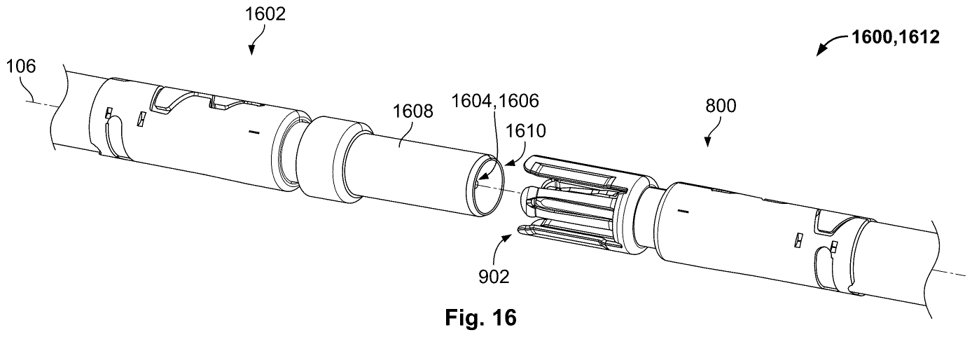

FIG. 16 shows an embodiment of a contact arrangement 1600, which may include a contact assembly 800 and a connector 1602 of a specified interface. The connector 1602 may have a contact 1604 of the specified interface. The contact 1604 of the specified interface may be configured as a pin 1606. Another embodiment may have a contact 1604 configured as a socket.

The connector 1602 of the specified interface may comprise a sleeve 1608. Both the contact 1604 of the specified interface and the sleeve 1608 may be arranged coaxially with respect to each other, for example along the center axis 106.

In the contact arrangement 1600, the contact assembly and connector 1602 of the specified interface can therefore be aligned coaxially with each other. The plug-side end 902 of the contact assembly 800 may face a plug-side end 1610 of the connector 1602 of the specified interface, in particular in an unmounted state 1612.

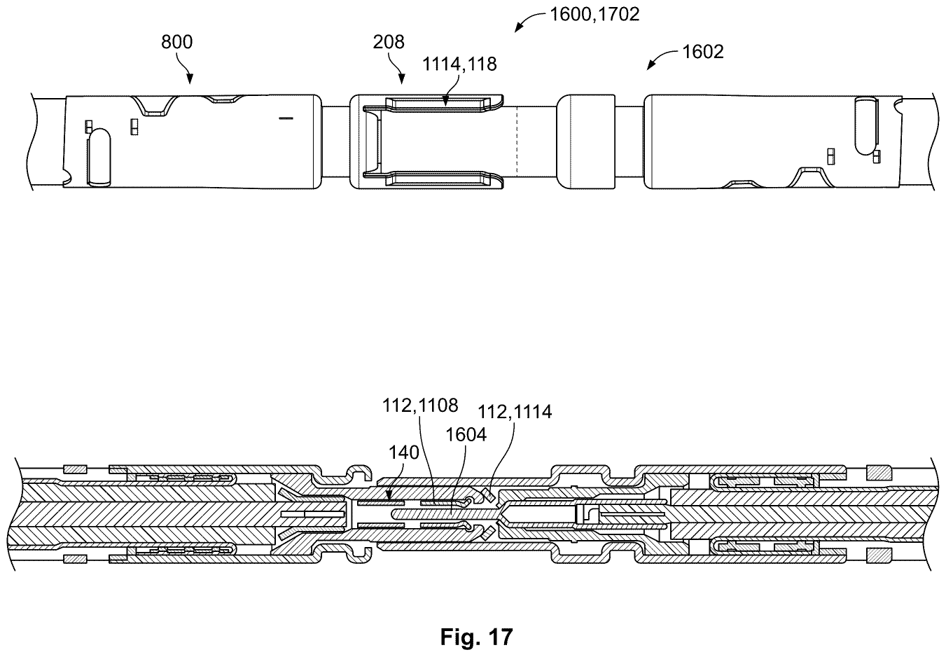

FIG. 17 shows an embodiment of the contact arrangement 1600 in the mounted state 1702. The outer lamellae 1114 of the contact assembly 800, i.e., for example, the secondary lamellae 118 of the outer contact 208, can surround the connector 1602 of the specified interface, in particular the circumference of the sleeve 1608, and contact it from the outside. The other lamellae of the outer contact 208, for example the primary lamellae 112, can contact the sleeve 1608 from the inside. In this context, “outside” refers to the side of the sleeve 1608 that faces away from the center axis 106, and “inside” refers to the side of the sleeve that faces toward the center axis 106.

FIG. 17 also shows a sectional view of the embodiment of the contact arrangement 1600. The sectional view shows that the lamellae of the inner contact 140, for example the primary lamellae 112 of the inner contact 140, surround the contact 1604 of the specified interface. In one embodiment, both primary lamellae 112 and secondary lamellae 118 can contact and, for example, surround the contact 1604 of the specified interface.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A contacting element for a contact assembly comprising:
a cable-side end; and
a plug-side end including a first lamella arrangement with at least two lamellae radially opposite each other with respect to a center axis of the contacting element and a second lamella arrangement with at least two lamellae radially opposite each other with respect to the center axis of the contacting element;
wherein the lamellae of the first lamella arrangement and the lamellae of the second lamella arrangement are arranged in a circumferential direction extending around the center axis at the plug-side end;
wherein the second lamella arrangement is offset in the circumferential direction relative to the first lamella arrangement; and
wherein the contacting element is configured to be plugged together with a further contacting element having an identical plug-side end along a plugin direction.

2. The contacting element according to claim 1, wherein the plug-side end is configured to be plugged together with an identical plug-side end of a further contacting element which is rotated relative to the first plug-side end about the center axis.

3. The contacting element according to claim 1, wherein the lamellae of the first lamella arrangement and of the second lamella arrangement protrude along the center axis from the plug-side end and extend along the center axis away from the plug-side end.

4. The contacting element according to claim 1, wherein, in a plugged-in state, the lamellae of the first lamella arrangement and of the second lamella arrangement of the contacting element are configured to overlap with the lamellae of a further contacting element in a radial direction.

5. The contacting element according to claim 1, wherein the lamellae of the first lamella arrangement have at least one shoulder which protrudes in the radial direction away from the center axis beyond the lamellae of the second lamella arrangement.

6. The contacting element according to claim 1, wherein the lamellae of the first lamella arrangement and the lamellae of the second lamella arrangement are configured differently.

7. The contacting element according to claim 1, wherein the contacting element is configured as an outer contact for the contact assembly.

8. The contacting element according to claim 1, wherein the contacting element is configured as an inner contact for the contact assembly.

9. A contact assembly comprising:
a contacting element including a cable-side end and a plug-side end, the plug side end including a first lamella arrangement with at least two lamellae radially opposite each other with respect to a center axis of the contacting element and a second lamella arrangement with at least two lamellae radially opposite each other with respect to the center axis of the contacting element, wherein the lamellae of the first lamella arrangement and the lamellae of the second lamella arrangement are arranged in a circumferential direction extending around the center axis at the plug-side end; wherein the second lamella arrangement is offset in the circumferential direction relative to the first lamella arrangement; and wherein the contacting element is configured to be plugged together with a further contacting element having an identical plug-side end along a plugin direction; and
an insulating body arranged coaxially with the contacting element.

10. The contact assembly according to claim 9, wherein the contacting element is configured as an outer contact for the contact assembly, the insulating body arranged coaxially with the outer contact.

11. The contact assembly according to claim 9, wherein the contacting element is configured as an inner contact for the contact assembly, the insulating body arranged coaxially with the inner contact.

12. The contact assembly according to claim 9, wherein the contacting element forms one of an inner contact or an outer contact, and wherein, in the radial direction, the insulating body is arranged between the inner contact and the outer contact.

13. The contact assembly according to claim 9, wherein the insulating body comprises a lamella arrangement with at least two lamellae radially opposite each other with respect to a center axis of the contacting element.

14. The contact assembly according to claim 9, wherein the insulating body comprises pockets in which lamellae of the first lamella arrangement and/or the second lamella arrangement of the contacting element are received.

15. The contact assembly according to claim 9, wherein the plug side end of the contacting element is configured to be connectable to a contact of a specified interface.

16. A contact assembly set comprising:
a first contact assembly and a second contact assembly, wherein the first contact assembly and the second contact assembly being identical and each including a contacting element including a cable-side end and a plug-side end, the plug side end including a first lamella arrangement with at least two lamellae radially opposite each other with respect to a center axis of the contacting element and a second lamella arrangement with at least two lamellae radially opposite each other with respect to the center axis of the contacting element, wherein the lamellae of the first lamella arrangement and the lamellae of the second lamella arrangement are arranged in a circumferential direction extending around the center axis at the plug-side end, wherein the second lamella arrangement is offset in the circumferential direction relative to the first lamella arrangement wherein the plug-side ends of the first and second contact assemblies are identically configured to be plugged together along a plugin direction, the lamellae of the first contact assembly being arranged between the lamellae of the second contact assembly in the plugged-in state.

17. The contact assembly set according to claim 16, wherein
the plug-side ends of the first and second contact assemblies face each other along the center axis in the plugged-in state; and
the lamellae of the contacting element of the first contact assembly overlap with the lamellae of the contacting element of the second contact assembly.

18. The contact assembly set according to claim 16, wherein the first and second contact assemblies each include an insulating body arranged coaxially with the corresponding contacting element.

19. The contact assembly set according to claim 16, wherein the contacting element is configured as an outer contact.

20. The contact assembly set according to claim 16, wherein the contacting element is configured as an inner contact.
